(19) United States
(12) Patent Application Publication
(10) Pub. No.: US 2007/0190209 A1
(43) Pub. Date: Aug. 16, 2007

(54) All natural multivitamin and multimineral dietary supplement formulations for enhanced absorption and biological utilization

(75) Inventor: Robert A. Sinnott, Keller, TX (US)

Correspondence Address: CHALKER FLORES, LLP, 2711 LBJ FRWY, Suite 1036, DALLAS, TX, 75234, US

(73) Assignee: Mannatech, Inc., Coppell, TX (US)

(21) Appl. No.: 11/586,841

(22) Filed: Oct. 26, 2006

Related U.S. Application Data
(60) Provisional application No. 60/772,081, filed on Feb. 10, 2006.

(51) Int. Cl. A23L 1/30

(52) U.S. Cl. 426/72

(57) ABSTRACT

The present invention includes compositions and methods for a dietary supplement formulation containing a standardized source of plant-derived minerals, one or more natural vitamins or provitamins and one or more natural plant extracts.

### CROSS REFERENCE TO RELATED APPLICATIONS

This application claims priority to, and is a non-provisional of U.S. Patent Application No. 60/772,081 filed Feb. 10, 2006, which is incorporated herein by reference.

### FIELD OF THE INVENTION

The present invention relates generally to compositions for human and animal consumption, and more particularly, to all-natural, multivitamin, multimineral dietary supplement formulations with enhanced absorption and biological utilization of nutrients.

### BACKGROUND OF THE INVENTION

Without limiting the scope of the invention, its background is described in connection with nutritional supplements.

Vitamins and minerals, antioxidants, and plant extracts have long been known to have beneficial health effects. Diets complete in nutritional substance are important for the human body to achieve high levels of performance, both in physical ability and mental health. Many factors affect physical and mental, e.g., environmental exposure, genetic background, exercise, nutrition, and the like. For many years it has been known that a diet fortified with certain vitamins, minerals, metals, co-factors and other nutrients is required when one or more of those nutrients are not provided or available in a balanced diet. The focus of many nutritional supplements is to maintain a balanced nutrition with daily exercise, which is fundamental to the well-being of the human body.

It is also known that an adequate supply of vitamins is essential in maintaining optimum health. The use of vitamins A, E, C and selenium has been proposed as a way to inhibit or prevent collagen cross-linking in human skin when used in combination with certain active peptides. In addition to their antioxidant activity, vitamins A, C, and E are known to have other beneficial health effects, e.g., vitamin E is known to help maintain proper blood sugar levels; vitamin C is known to play an integral role in the integrity of connective and structural tissues in the body; and Vitamin A is known to play a role in maintaining good vision as well as in growth and development.

The beneficial aspects of antioxidants, which have been known for many years, include reacting with free radicals, such as hydroxyl radicals, to protect certain biological systems. Reduction in the levels of free radicals has been found to increase the longevity of cells. For example, U.S. Pat. No. 5,149,321, issued to Klatz et al., teaches that Antioxidants are known to limit destruction of healing brain tissue by free radicals as shown by the method for resuscitating the brain using vitamins such as A, E and C or selenium.

What is needed is a source of preservative-free compositions, optimized to increase the nutrients bioavailability by maximizing the beneficial effects of certain nutrients as well as by minimizing known inhibitory effect. Also needed is a source of bioavailable, generally preservative-free compositions that maximize the beneficial effects of certain nutrients that are also optimized to minimize known inhibitory effect.

A healthy balance of vitamins and minerals is critical to sustain a healthy human body, however, many combinations of vitamins and minerals are counter-productive because they include combinations that, until now, were not known to be detrimental, inhibitory or that negatively modulate uptake. Therefore, there remains a need in the art for daily food supplements that maximize uptake with decreased digestive problems, and that provide supplementation for bones and the like.

### SUMMARY OF THE INVENTION

The present invention relates generally to dietary supplement compositions for human and animal consumption, that include a combination of natural vitamin sources, plant-derived mineral sources, and plant-based compositions (e.g., extracts, dehydrated plant materials, gums, etc.) with standardized phytochemicals. These compositions maximize and/or optimize the delivery of specific nutrients, and may be made available in a wide variety of dosage forms.

More particularly, the present invention includes a dietary supplement formulation having a standardized source of plant-derived minerals, one or more natural vitamins or provitamins and one or more plant extracts. Examples of plant-derived minerals include one or more of the minerals selected from calcium, magnesium, iron, zinc, selenium, chromium, vanadium, copper, manganese, molybdenum, boron, iodine, strontium and combinations thereof. Compositions of plant-derived minerals may be provided from seedlings of Brassica napus, Brassica rapa, Brassica juncea, Medicago sativa, and Oryzae sativa seeds.

Examples of one or more natural vitamins include, e.g., vitamin A, carotenoids, lycopene, lutein, zeaxanthin, cryptoxanthin, thiamine, pantothenic acid, riboflavin, niacin, vitamin B-6, folate, vitamin B-12, vitamin C, vitamin D, vitamin E, tocopherols, tocotrieneols and combinations thereof. Examples of one or more standardized include phytochemicals, e.g., sulforaphanes, isothiocyanates, glucosinolates, glucoraphanin, gluconasturtiin, glucobrassicin, glucoerucin, S-methyl cysteine sulfoxide, indole-3-carbinol, erucin, xanthophylls, carotenoids, lycopene, lutein, cryptoxanthin, beta-carotene, polyphenolics, flavonoids, apigenin, rutin, quercetin, chrysin, hesperidin, bioflavonoids, isoflavones, anthocyanins, chlorogenic acid, ECGC, ellagic acid, catechins, aescin, resveratrol, curcumin, lignins, carnosic acid, rosemarinic acid, gingerol, oleuropein, silymarin, sinigrin, rutin, quinic acid, and combinations thereof.

The supplement may also include one or more a natural polysaccharide ingredients, e.g., a plant polysaccharide, an algal polysaccharide, a fungal polysaccharide, a bacterial polysaccharide, a plant gum, an aloe polysaccharide, and combinations thereof. In certain embodiments, the mono, oligo- or polysaccharides, are selected to provide 2, 3, 4, 5, 6, 7 or 8 essential saccharides.

The present invention also includes a dietary supplement formulation to support bone health including a standardized source of plant-derived zinc, a standardized plant extract including carotenoids, xanthophylls, beta-carotene, lycopene, lutein, zeaxanthin, and cryptoxanthin; and one or more additional nutrients including vitamin D, vitamin C, calcium, magnesium, strontium, and boron.

The plant-derived minerals to support bone health may be selected from the group consisting of seedlings of Brassica napus, Brassica rapa, Brassica juncea, Medicago, sativa, Oryzae sativa seeds, and the like. The skilled artisan will recognize that other plants may be discovered, developed or engineered that can provide equivalent or better delivery of plant-based minerals, all of which are incorporated herein as equivalents. The plant-derived minerals to support bone health may include one or more of the minerals selected from iron, selenium, chromium, vanadium, copper, manganese, molybdenum, iodine, and combinations thereof. The one or more natural vitamins to support bone health may be selected from vitamin A, thiamine, riboflavin, niacin, vitamin B-6, folate, vitamin B-12, pantothenic acid, vitamin C, vitamin D, vitamin E, tocopherols, tocotrieneols, and combinations thereof.

The supplement of the present invention may be provided in a wide variety of dosage forms, different concentrations, ratios and the like, e.g., external capsule, a vegetable capsule or a hard gelatin capsule. When in a tablet form the supplement is compressed at a pressure greater than 2,000 psi. When in the form of a modified or extended release about 85% of the nutritional supplements are released from between about 1 to about 8 hours, and even, about 85% of the nutritional supplements are released from between about 2 to about 6 hours. The supplement further one or more excipients.

The supplement of the present invention may be provided in bulk powder form, e.g., as a dietary supplement composition for human and animal consumption, that includes a combination of natural vitamin sources, plant-derived mineral sources and plant-based compositions (e.g., extracts, dehydrated plant materials, gums, etc.) with standardized phytochemicals to meet the dietary requirements and/or needs of the human or animal. In one specific example, the bulk powder is provided with few, if any, fillers and include the natural vitamin sources, plant-derived mineral sources, and plant-based compositions (e.g., extracts, dehydrated plant materials, gums, etc.) with standardized phytochemicals, e.g., an InB Mineral Blend (125 mg) that includes: zinc (0.03 to 3.5 mg), iron (0.03 to 3.5 mg), manganese (0.03 to 3.5 mg), chromium (0.03 to 3.5 mg), copper (0.03 to 3.5 mg), selenium (0.03 to 3.5 mg), vanadium (0.03 to 3.5 mg), molybdenum (0.03 to 3.5 mg), boron (0.03 to 3.5 mg), iodine (0.03 to 3.5 mg); Aquamins (100 mg), e.g., 30% Ca (2.5 to 30 mg) and/or 2.5% Mg (2.5 to 30 mg); BroccoSinolate (20 to 160 mg), e.g., 6% glucosinolates (1.2 to 20 mg); Rutin NF (1.2 to 20 mg); Cranberry extract (35% org acids) (1.2 to 20 mg); Grape pomace extract (50% poly) (1.2 to 20 mg); and Aloe gel powder (200×) (1.2 to 20 mg). In addition, the bulk powder may include: yeast vitamin complex (0.038 to 4 mg), thiamin (0.038 to 4 mg), riboflavin (0.038 to 4 mg), niacin (0.038 to 4 mg), pyridoxine (0.038 to 4 mg), pantothenic acid (0.038 to 4 mg), folic acid (0.038 to 4 mg), biotin (0.038 to 4 mg); and one or more of the following vitamins: Mixed carotenoid powder (35,000 IU/g), Vitamin B12 1% (yeast derived) (15 mcg), Acerola cherry (15% Vitamin C)(0.15 to 100 mg), Vitamin D (100K I/g) (0.15 to 100 mg), Vitamin E (350 IU/g) (0.15 to 100 mg), or combinations thereof.

In one example, the dietary supplement of the present invention is provided in liquid, gel, gelcap, gelatin or other form that is particularly palatable to those users, such as children and adults unwilling or incapable or swallowing a hard tables, that include the composition of the present invention. One such form is that of a plant pectin formulation that includes, e.g., an InB Mineral Blend (125 mg) that includes: zinc (0.03 to 3.5 mg), iron (0.03 to 3.5 mg), manganese (0.03 to 3.5 mg), chromium (0.03 to 3.5 mg), copper (0.03 to 3.5 mg), selenium (0.03 to 3.5 mg), vanadium (0.03 to 3.5 mg), molybdenum (0.03 to 3.5 mg), boron (0.03 to 3.5 mg), iodine (0.03 to 3.5 mg); Aquamins (100 mg), e.g., 30% Ca (2.5 to 30 mg) and/or 2.5% Mg (2.5 to 30 mg); BroccoSinolate (20 to 160 mg), e.g., 6% glucosinolates (1.2 to 20 mg), Rutin NF (1.2 to 20 mg); Cranberry extract (35% org acids) (1.2 to 20 mg); Grape pomace extract (50% poly) (1.2 to 20 mg); and Aloe gel powder (200×) (1.2 to 20 mg). In addition, the composition may include: yeast vitamin complex (0.038 to 4 mg), thiamin (0.038 to 4 mg), riboflavin (0.038 to 4 mg), niacin (0.038 to 4 mg), pyridoxine (0.038 to 4 mg), pantothenic acid (0.038 to 4 mg), folic acid (0.038 to 4 mg), biotin (0.038 to 4 mg), and one or more of the following vitamins: Mixed carotenoid powder (35,000 IU/g vitamin A equivalents), Vitamin B12 1% (yeast derived) (15 mcg), Acerola cherry (15% Vitamin C)(0.15 to 100 mg), Vitamin D (100K I/g) (0.15 to 100 mg), Vitamin E (350 IU/g) (0.15 to 100 mg), or combinations thereof. When provided for pediatric form, the composition may include one-half or less of the total amount listed hereinabove or based on the weight to weight ratios produced by the ranges listed as long as the formulation is provided in a size and form that is acceptable for pediatric use. In some cases where the patient is in need of more or less of certain of the natural vitamins and minerals described herein, a specific formulation may be prepared as is known to those of skill in the art.

The present invention also includes a method for providing a balanced nutritional supplement that includes selecting one or more standardized source of plant-derived minerals, one or more natural vitamins or provitamins and one or more plant extracts, wherein the one or more components of the supplement are synergistic as measured by bioavilability. The composition may include a standardized source of plant-derived minerals including, e.g., calcium, magnesium, iron, zinc, selenium, chromium, vanadium, copper, manganese, molybdenum, boron, iodine, and strontium; one or more natural vitamins or provitamins including, vitamin A, carotenoids, lycopene, lutein, zeaxanthin, cryptoxanthin, thiamine, riboflavin, niacin, vitamin B6, pantothenic acid, folate, vitamin B12, vitamin C, vitamin D, vitamin E, tocopherols, tocotrieneols; and one or more standardized plant extracts including plant phenolic compounds, polyphenolics, flavonoids, apigenin, rutin, quercetin, chrysin, hesperidin, bioflavonoids, isoflavones, anthocyanins, chlorogenic acid, ECGC, ellagic acid, catechins, aescin, resveratrol, curcumin, lignins, tannins, tannic acid, gingerol, sinigrin, oleuropein, and combinations thereof.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the invention, except as outlined in the claims.

The present invention may be used alone or in combination with one or more method, techniques, mechanical, chemical and other modification, encapsulation, packaging and the like for delaying the release of the nutrient, e.g., a capsule, a gelcap or even a coating. Examples of capsules include animal, vegetable, polymeric, mixtures, and combinations thereof. The coating (type, thickness, etc) may be applied to a sufficient thickness such that part or the entire coating does not dissolve in the gastrointestinal fluids at pH below about 5, but does dissolve at pH about 5 and above.

As used herein the term “nutritionally effective amount” is used to define the amount that will provide a beneficial nutritional effect or response in a mammal. For example, as nutritional response to vitamin- and mineral-containing dietary supplements varies from mammal to mammal, it should be understood that nutritionally effective amounts of the vitamins and minerals will vary, respectively. Likewise, the lack of an essential amino acid, vitamin-C, iron, iodine, vitamins, minerals, carbohydrates, lipids and the like are known to affect physiological and cellular functions. A nutritionally effective amount of the anti-oxidants and saccharides disclosed herein serve to preserve and/or elevate the levels of these critical nutrients in the diet of, e.g., a human that seeks to maintain or augment their diet for these nutritional supplements. Thus, while one mammal may require a particular profile of vitamins and minerals present in defined amounts, another mammal may require the same particular profile of vitamins and minerals present in different defined amounts.

As used herein, the “antioxidant” refers to any molecule that delays or prevents the oxidation of an oxidizable target molecule. Antioxidants act by: scavenging biologically important reactive free radicals or other reactive oxygen species (e.g., O₂⁻, H₂O₂, HOCl, ferryl, peroxyl, peroxynitrite, and alkoxyl); preventing oxygen radical formation; or catalytically converting the free radical or other reactive oxygen species to a less reactive species. Antioxidants are generally divided into two classes: (1) lipid (lipophilic or hydrophobic) antioxidants; and (2) aqueous (lipophobic or hydrophilic) antioxidants. Examples of lipid antioxidants include, but are not limited to, carotenoids (e.g., lutein, zeaxanthin, β-cryptoxanthin, lycopene, α-carotene, and β-carotene), which are located in the core lipid compartment, tocopherols (e.g., vitamin E, α-tocopherol, γ-tocopherol, and δ-tocopherol), which are located in the interface of the lipid compartment, retinoids (e.g., vitamin A, retinol, and retinyl palmitate), and fat-soluble polyphenols, e.g., quercetin, rutin, and the like. Examples of aqueous antioxidants include, but are not limited to, ascorbic acid and its oxidized form, “dehydroascorbic acid,” uric acid and its oxidized form “allantoin,” bilirubin, albumin, vitamin C, and water-soluble polyphenols, such as isoflavones, procyanidins, and catechins, which have high affinity for the phospholipid membranes.

As used herein, the term “acceptable salt” of the nutrients is used to describe those salts that are, within the scope of sound medical judgment, suitable for use in, on or with the tissues of humans and lower animals without undue toxicity, irritation, allergic response and the like and are commensurate with a reasonable benefit/risk ratio. Acceptable salts are well-known in the art (see e.g., S. M. Berge, et al., J. Pharmaceutical Sciences, 1977, relevant portions incorporated herein by reference) and may be prepared during the final isolation and purification of the compounds of the invention or separately by reacting a free base function with a suitable organic acid. Representative acid addition salts include, but are not limited to acetate, adipate, alginate, citrate, aspartate, benzoate, benzene sulfonate, bisulfate, butyrate, camphorate, camphor sulfonate, digluconate, glycerophosphate, hemisulfate, heptanoate, hexanoate, fumarate, hydrochloride, hydrobromide, hydroiodide, 2-hydroxyethansulfonate (isothionate), lactate, maleate, methane sulfonate, nicotinate, 2-naphthalene sulfonate, oxalate, palmitoate, pectinate, persulfate, 3-phenylpropionate, picrate, pivalate, propionate, succinate, tartrate, thiocyanate, phosphate, glutamate, bicarbonate, p-toluene sulfonate and undecanoate. Examples of basic nitrogen-containing groups that are used as quaternizing agents include: lower alkyl halides (methyl, ethyl, propyl, and butyl chlorides, bromides and iodides); dialkyl sulfates (dimethyl, diethyl, dibutyl and diamyl sulfates); long-chain halides (decyl, lauryl, myristyl and stearyl chlorides, bromides and iodides); arylalkyl halides (benzyl and phenethyl bromides) and the like. Examples of acids that may be employed to form pharmaceutically acceptable acid addition salts include inorganic acids, e.g., hydrochloric acid, hydrobromic acid, sulphuric acid, and phosphoric acid and such organic acids as oxalic acid, maleic acid, succinic acid, and citric acid. Basic addition salts can also be prepared in situ during the final isolation and purification of anti-oxidant compounds disclosed herein with a suitable base such as the hydroxide, carbonate or bicarbonate of a pharmaceutically acceptable metal cation or with ammonia or an organic primary, secondary or tertiary amine. Pharmaceutically acceptable salts include, but are not limited to, cations based on alkali metals or alkaline earth metals such as lithium, sodium, potassium, calcium, magnesium and aluminum salts and the like, and nontoxic quaternary ammonia and amine cations including ammonium, tetramethylammonium, tetraethylammonium, methylammonium, dimethylammonium, trimethylammonium, triethylammonium, diethylammonium, and ethylammonium among others. Other representative organic amines useful for the formation of base addition salts include ethylenediamine, ethanolamine, diethanolamine, piperidine, piperazine, and the like.

As used herein, the terms “glyconutritional” or “glyconutrient” refer to complex carbohydrates or saccharides or simple sugars that are synthesized in nature and are necessary for the biochemical synthesis of various classes of communication and signal molecules that may be free in interstitial cellular fluids, active in cell to cell communication (i.e., cytokines, growth factors, etc.), or constitute the molecular configuration comprising loci of highly specific molecular activity of cell membranes (i.e., receptor sites, ion-transport channels, antigenic identification, and the like).

As used herein the term “isolated” refers to an organic molecule or group of similar molecules that have been subjected to fractionation to remove various other components and that retain substantially its expressed biological activity. Where the term “substantially purified” is used, this designation will refer to a composition in which the active form of the nutrients of the composition constitute about 10%, 20%, 30%, 40%, 50%, 60%, 70%, 80%, 90%, 95% or more of the total molecules in the composition. In some cases the active form of the nutrient can not be successfully removed from its normal cellular milieu without affecting its activity. In fact, the present invention takes advantage of the local environment to the extent possible to deliver the highest quality and quantity of active, nutritional compounds. However, in some cases a balance is achieved between the level of processing or “isolation”, the effectiveness of the compound and the overall cost and impact on the environment. The skilled artisan will recognize that it is possible to maximize the effectiveness of the compound while at the same time being responsible stewards of the environment. In the case of plants, e.g., native plants, a balance must also be maintained with the local culture and community to minimize the impact of the production of plants that include the nutritional compounds isolated for use with the present invention.

As used herein, the terms “phytonutritional” or “phytonutrient” refer to naturally synthesized molecules found only in plants that are produced to protect the plant's cells. Phytonutrients primarily have antioxidant, free-radical scavenger and vital micronutrient activity. These molecules, supplied through dietary supplementation, are found in mature plant tissues, and are most concentrated in seed coats and fruiting tissues surrounding the seed. In mammalian tissues, these molecules, when supplied in the diet, are active in optimizing the biochemistry, immunology and physiology in the cellular micro-environment.

As used herein, the terms “plant-derived”, “plant powders”, “plant extract” “dehydrated plant powders”, “dehydrated plant extracts”, and “herbal extract” are used interchangeably to refer to “phytochemicals” that are produced in plant tissues and that can be obtained from plants or herbs by isolating at least a part of the plant away from its natural state, e.g., by removing water (e.g., extracting the juice and/or pulp), extracting one or more components chemically, mechanically, thermally, by size or otherwise separating the components using polar, non-polar, mineral, petroleum or other solvents, and that have some degree of beneficial health or therapeutic activity. The isolation of the active agent from the plant will depend on the nature of the active agent, e.g., water soluble, insoluble, miscible and the like, sensitivity to decomposition (e.g., denaturation by heat, pH, oxygen, light, etc.). Plant extracts also include dehydrated plant materials in which the bulk liquid is removed to concentrate the bioavailable solids in the plant or herb. Most herbal agents can be toxic, especially when concentrated, but are generally safe when utilized in their more traditional manner in teas and poultices as a “folk medicinal for the treatment of disease and promotion of good health.”

The carbohydrates included in the dietary supplement of the invention are available from a wide variety of natural and synthetic sources such as shrubs, trees, plants, yeasts, fungi, molds, gums, resins, starch and cellulose derivatives and natural mucin sources. Specifically, some of the natural sources include: (a) shrub or tree exudates which contain acacia, karaya, tragacanth, or ghatti; (b) marine gums which include agar, algin, or carrageenan; (c) seed gums which include guar, locust bean, or psyllium; (d) plant extracts which contain pectins or acetylated polymannose; (e) starch and cellulose derivatives such as carboxymethylcellulose, ethylcellulose, hydroxypropyl methylcellulose, methylcellulose, oxidized cellulose; and microbial gums which contain dextrans, and xanthan. However, it should be recognized that the composition of the invention is not intended to be limited by the source from which the respective carbohydrates are obtained.

As used herein, the terms “natural vitamin” and “natural mineral” refer to vitamins and minerals derived from, and to the extent possible maintained in, a state similar or equivalent to that in which they are found in a natural state, e.g., included with other nutrients normally associated with the vitamin or mineral and that are not available from synthetic vitamins or minerals as part of a plant. Examples of natural vitamins and minerals are those that are grown in plants and other cells that concentrate vitamins and minerals in or about cellular structures. For example, hydroponic plants and even cells grown in culture may be modified through breeding, recombinant genetic manipulation or by exposure to certain nutrients to enhance the normal amounts of vitamins and minerals in the plant or cell. These plants or cells are then harvested and the natural vitamins or natural minerals are obtained from the plants for use with the present invention. While some extraction procedures may be involved in separating the natural vitamins or natural minerals from the plant or cell source, the processing steps are limited as much as possible to maintain the natural vitamins or natural minerals in as natural a state as possible.

As used herein, the term “carbohydrate” is used interchangeably with the terms “saccharide,” “polysaccharide,” “oligosaccharide” and “sugar” the definitions of which are well known to those skilled in the art of carbohydrate chemistry. Although the compositions of the invention are intended to include at least two or more essential saccharides, it should be noted that the saccharides can be in the form of mono-, oligo- and/or polysaccharides, e.g., a composition containing gum tragacanth and guar gum will be considered as containing galacturonic acid, sialic acid, mannose and galactose. Therefore, by controlling the amount of particular gums in a given dietary supplement, one can control the amount of the respective saccharides in the dietary supplement.

The saccharides of the invention can be found in nature as mono-, oligo- and/or polysaccharides. Thus, the compositions of the invention can contain the saccharides in their monomeric, oligomeric and/or polymeric forms. For a list of known natural sources for the saccharides and their uses, please refer to U.S. patent application No. 2003072770, relevant portions incorporated herein by reference.

In some embodiments, the active agents of the present invention may be prepared for delivery in a modified or delayed release form. For example, when the agent is acid sensitive, the agent may be delivered with an enteric coating to reach the intestinal tract before release. As used herein, the terms “modified release,” “extended release” and “controlled release” describe one or more release profiles to effect delivery of a nutritionally effective amount of a nutrient over an extended period of time, defined herein as being between about 60 minutes and about 2, 4, 6, 8 or more hours using the formulation of the present invention. Modified release may also be defined functionally as the release of over 80 to 90 percent (%) of the nutrient after about 60 minutes and about 2, 4, 6, or even 8 hours. The release may also be evaluated by making the natural vitamins or natural minerals available to the user regardless of uptake, as some actives may never be absorbed by the animal. Various modified release dosage forms may be designed readily by one of skill in art as disclosed herein to achieve delivery to both the small and large intestines, to only the small intestine, or to only the large intestine, depending upon the choice of coating materials and/or coating thickness. Examples of modifications that can be made to the long-chain polysaccharides include, e.g., changing the types or composition of saccharides in the long-chain polysaccharides, chemically modifying (organically or chemically) the side chains of the saccharides (e.g., acetylation), hydrolyzing the long-chain polysaccharides, sizing the long-chain polysaccharides, polymerizing longer long-chain polysaccharides, selecting combinations of shorter and longer long-chain polysaccharides, separating the long-chain polysaccharides by, e.g., electroporation, FPLC, HPLC, size-exclusion, size-exclusion chromatography, precipitation and the like. Extended release formulations may be prepared and delivered so that release is accomplished at some generally predictable location in the lower intestinal tract more distal to that which would have been accomplished if there had been no modified release alterations.

Techniques and compositions for making useful dosage forms using the present invention are described in one or more of the following references: Ansel, Introduction to Pharmaceutical Dosage Forms 2nd Edition (1976); Remington's Pharmaceutical Sciences, 17th ed. (Mack Publishing Company, Easton, Pa., 1985); Advances in Pharmaceutical Sciences (David Ganderton, Trevor Jones, Eds., 1992); Advances in Pharmaceutical Sciences Vol 7. (David Ganderton, Trevor Jones, James McGinity, Eds., 1995); Aqueous Polymeric Coatings for Pharmaceutical Dosage Forms (Drugs and the Pharmaceutical Sciences, Series 36 (James McGinity, Ed., 1989); Pharmaceutical Particulate Carriers: Therapeutic Applications: Drugs and the Pharmaceutical Sciences, Vol 61 (Alain Rolland, Ed., 1993); Drug Delivery to the Gastrointestinal Tract (Ellis Horwood Books in the Biological Sciences. Series in Pharmaceutical Technology; J. G. Hardy, S. S. Davis, Clive G. Wilson, Eds.); Modern Pharmaceutics Drugs and the Pharmaceutical Sciences, Vol 40 (Gilbert S. Banker, Christopher T. Rhodes, Eds.), and the like, relevant portions incorporated herein by reference.

For example, the compositions of the present invention may be included in a tablet. Tablets may contain, e.g., suitable binders, lubricants, disintegrating agents, coloring agents, flavoring agents, flow-inducing agents, gummy agents, chewing agents and/or melting agents. For example, oral administration may be in a dosage unit form of a tablet, gelcap, caplet or capsule, the active drug component being combined with a non-toxic, pharmaceutically acceptable, inert carrier such as lactose, gelatin, agar, starch, sucrose, glucose, methyl cellulose, magnesium stearate, dicalcium phosphate, calcium sulfate, mannitol, sorbitol, mixtures thereof, and the like. Suitable binders for use with the present invention include: starch, gelatin, natural sugars (e.g., glucose or beta-lactose), corn sweeteners, natural and synthetic gums (e.g., acacia, tragacanth or sodium alginate), carboxymethylcellulose, polyethylene glycol, waxes, and the like. Lubricants for use with the invention may include: sodium oleate, sodium stearate, magnesium stearate, sodium benzoate, sodium acetate, sodium chloride, dicalcium phosphate, and mixtures thereof, and the like. Disintegrators may include: starch, methyl cellulose, agar, bentonite, xanthan gum, mixtures thereof, and the like.

The compositions described herein, namely, a standardized source of plant-derived minerals, one or more natural vitamins or provitamins and one or more plant extracts, may be administered in the form of liposome delivery systems, e.g., small unilamellar vesicles, large unilamallar vesicles, and multilamellar vesicles, whether charged or uncharged. Liposomes may include one or more: phospholipids (e.g., cholesterol), stearylamine and/or phosphatidylcholines, mixtures thereof, and the like.

The standardized source of plant-derived minerals, one or more natural vitamins or provitamins and one or more plant extracts may also be coupled to one or more soluble, biodegradable, bioacceptable polymers as drug carriers or as a prodrug. Such polymers may include: polyvinylpyrrolidone, pyran copolymer, polyhydroxylpropylmethacrylamide-phenol, polyhydroxyethylasparta-midephenol, or polyethyleneoxide-polylysine substituted with palmitoyl residues, mixtures thereof, and the like. Furthermore, the compositions may be coupled one or more biodegradable polymers to achieve controlled release of the standardized source of plant-derived minerals, one or more natural vitamins or provitamins and/or one or more plant extracts, biodegradable polymers for use with the present invention include: polylactic acid, polyglycolic acid, copolymers of polylactic and polyglycolic acid, polyepsilon caprolactone, polyhydroxy butyric acid, polyorthoesters, polyacetals, polydihydropyrans, polycyanoacylates, and crosslinked or amphipathic block copolymers of hydrogels, mixtures thereof, and the like.

In one embodiment, gelatin capsules (gelcaps) may include the standardized source of plant-derived minerals, one or more natural vitamins or provitamins, and one or more plant extracts and powdered carriers, such as lactose, starch, cellulose derivatives, magnesium stearate, stearic acid, dicalcium phosphate, and the like. Like diluents may be used to make compressed tablets. Both tablets and capsules may be manufactured as immediate-release, mixed-release or sustained-release formulations to provide for a range of release of medication over a period of minutes to hours. Compressed tablets may be sugar coated or film coated to mask any unpleasant taste and protect the tablet from the atmosphere. An enteric coating may be used to provide selective disintegration in, e.g., the gastrointestinal tract.

For oral administration in a liquid dosage form, the oral drug components may be combined with any oral, non-toxic, pharmaceutically acceptable inert carrier such as ethanol, glycerol, water, and the like. Examples of suitable liquid dosage forms include solutions or suspensions in water, pharmaceutically acceptable fats and oils, alcohols or other organic solvents, including esters, emulsions, syrups or elixirs, suspensions, solutions and/or suspensions reconstituted from non-effervescent granules and effervescent preparations reconstituted from effervescent granules. Such liquid dosage forms may contain, for example, suitable solvents, preservatives, emulsifying agents, suspending agents, diluents, sweeteners, thickeners, and melting agents, mixtures thereof, and the like.

Liquid dosage forms for oral administration may also include coloring and flavoring agents that increase patient acceptance and therefore compliance with a dosing regimen. In general, water, a suitable oil, saline, aqueous dextrose (e.g., glucose, lactose and related sugar solutions) and glycols (e.g., propylene glycol or polyethylene glycols) may be used as suitable carriers for parenteral solutions. Solutions for parenteral administration include generally, a water soluble salt of the active ingredient, suitable stabilizing agents, and if necessary, buffering salts. Antioxidizing agents such as sodium bisulfite, sodium sulfite and/or ascorbic acid, either alone or in combination, are suitable stabilizing agents. Citric acid and its salts and sodium EDTA may also be included to increase stability. In addition, parenteral solutions may include pharmaceutically acceptable preservatives, e.g., benzalkonium chloride, methyl- or propyl-paraben, and/or chlorobutanol. Suitable pharmaceutical carriers are described in Remington's Pharmaceutical Sciences, Mack Publishing Company, a standard reference text in this field, relevant portions incorporated herein by reference.

Capsules. Capsules may be prepared by filling standard two-piece hard gelatin capsules each with 1 to 1000 milligrams of powdered active ingredient, 0.5 to 150 milligrams of lactose, 0.1 to 500 milligrams of cellulose and 0.1 to 60 milligrams magnesium stearate.

Soft Gelatin Capsules. A mixture of active ingredient is dissolved in a digestible oil such as soybean oil, cottonseed oil, or olive oil, and the like. The active ingredient is prepared and injected by using a positive displacement pump into gelatin to form soft gelatin capsules containing, e.g., 100-500 milligrams of the active ingredient. The capsules are washed and dried.

Tablets. A large number of tablets are prepared by conventional procedures so that the dosage unit was 100-500 milligrams of active ingredient, 0.2 milligrams of colloidal silicon dioxide, 5 milligrams of magnesium stearate, 50-275 milligrams of microcrystalline cellulose, 11 milligrams of starch and 98.8 milligrams of lactose. Appropriate coatings may be applied to increase palatability or delay absorption.

To provide an effervescent tablet appropriate amounts of, e.g., monosodium citrate and sodium bicarbonate, are blended together and then roller compacted, in the absence of water, to form flakes that are then crushed to give granulates. The granulates are then combined with the active ingredient, drug and/or salt thereof, conventional beading or filling agents and, optionally, sweeteners, flavors and lubricants.

Injectable solution. A parenteral composition suitable for administration by injection is prepared by stirring 1.5% by weight of active ingredient in deionized water and mixed with, e.g., up to 10% by volume propylene glycol and water. The solution is made isotonic with sodium chloride and sterilized using, e.g., ultrafiltration.

Suspension. An aqueous suspension is prepared for oral administration so that each 5 ml contain 100 mg of finely divided active ingredient, 200 mg of sodium carboxymethyl cellulose, 5 mg of sodium benzoate, 1.0 g of sorbitol solution, U.S.P., and 0.025 ml of vanillin.

For mini-tablets, the active ingredient is compressed into a hardness in the range 6 to 12 Kp. The hardness of the final tablets is influenced by the linear roller compaction strength used in preparing the granulates, which are influenced by the particle size of, e.g., the monosodium hydrogen carbonate and sodium hydrogen carbonate. For smaller particle sizes, a linear roller compaction strength of about 15 to 20 KN/cm may be used.

For a gummy consumable, the present invention may be combined with the teachings of, e.g., U.S. Pat. No. 5,928,664, issued to Yang, et al., relevant portions incorporated herein by reference. Briefly, a consumable gummy delivery system is taught in which the present invention is combined into a gummy delivery systems that includes an active ingredient admixed with a glycerylated gelatin matrix prepared by heating an aqueous solution of gelatin and glycerin to a temperature and for a time sufficient to remove some of the moisture content of the initial aqueous solution. The active ingredients taught herein can be delivered from a shearform matrix carrier. For a plant-based formulation to provide a gummy consistency, the present invention may use the compositions and methods taught in, e.g., U.S. Pat. No. 6,586,032 issued to Grazela, et al., relevant portions incorporated herein by reference. Briefly, a gelatin-free gummy confection using gellan gum and carrageenan, which provides a firm, resilient, gelatin-like texture in a gelatin-free gummy confection.

Kits. The present invention also includes kits useful, for example, for the treatment of nutritional deficiencies in which one or more containers that include a compositions composition comprising a therapeutically effective amount of a standardized source of plant-derived minerals, one or more natural vitamins or provitamins and one or more plant extracts. Such kits may further include, if desired, one or more of various conventional pharmaceutical kit components, such as, for example, containers with one or more pharmaceutically acceptable carriers, additional containers, etc., as will be readily apparent to those skilled in the art. Printed instructions, either as inserts or as labels, indicating quantities of the components to be administered, guidelines for administration, and/or guidelines for mixing the components, may also be included in the kit. It should be understood that although the specified materials and conditions are important in practicing the invention, unspecified materials and conditions are not excluded so long as they do not prevent the benefits of the invention from being realized.

Tablets may contain suitable binders, lubricants, diluents, disintegrating agents, coloring agents, flavoring agents, flow-inducing agents, and melting agents. Examples of suitable liquid dosage forms include solutions or suspensions in water, pharmaceutically acceptable fats and oils, alcohols or other organic solvents, including esters, emulsions, syrups or elixirs, suspensions, solutions and/or suspensions reconstituted from non-effervescent granules and effervescent preparations reconstituted from effervescent granules. Such liquid dosage forms may contain, for example, suitable solvents, preservatives, emulsifying agents, suspending agents, diluents, sweeteners, thickeners, and melting agents. Oral dosage forms optionally contain flavorants and coloring agents. Parenteral and intravenous forms may also include minerals and other materials to make them compatible with the type of injection or delivery system chosen.

The present invention relates generally to dietary supplement compositions that include a combination of natural vitamin sources, plant-derived mineral sources and plant extracts with standardized phytochemicals. These formulations have utility in producing nutritional products with enhanced consumer appeal and effectiveness for delivery of key nutrients, that is, it has been found that these natural vitamin sources have greater nutritional effectiveness that synthetic counterparts that have been purified away from their natural environment. Research suggests that at least some of these key nutrients occur at insufficient levels in many human diets. By synthesizing the various bits of available scientific data, it appears that it is plausible to formulate novel vitamin, mineral and phytochemical dietary supplements which take advantage of the complex and sometimes counterintuitive interactions that occur when these ingredients are dosed concurrently. These formulations have significant and unanticipated advantages for human nutrition, including enhanced absorption of certain components in the formulation and ingested before, during or after taking the supplement, improved nutrient utilization and enhancement of chemoprotective metabolism. In some cases, the present invention may include instructions for use along with foods to aid in their digestion. (i.e., digestion of the supplement, the food or both).

Plant-derived minerals having increased bioavailability. Adequate mineral nutrition is a key component of health. The vast majority of vitamin and mineral supplements on the market today use U.S.P. minerals as the sole mineral source. The solubility of U.S.P. minerals in the gastrointestinal tract and their subsequent bioavailability has increasingly come into question. Many alternate forms of minerals, including amino acid chelates, organic acid salts, etc., buffered salts have been employed with mixed results to address the problem of mineral solubility. One unique potential solution to the issue of mineral solubility and bioavailability includes the use of plant-derived mineral derived from species of plants that hyperaccumulate minerals. One plant that has been the subject of intensive development is Brassica juncea (Indian mustard). In published studies, it has been shown that this plant species can hyperaccumulate concentrated levels of several mineral nutrients, including: chromium, iron, manganese, selenium and zinc. The plant material can then be harvested, dried and ground into a powder for incorporation into dietary supplement formulations as a mineral source. Orser, et al. (1998/1999) and Elless, et al. (2000).

For use with the present invention, the incorporation of minerals into all-natural, plant sources may be as taught in U.S. Pat. No. 6,270,809 issued to Ensley, et al., which teaches certain nutritional supplements that include compositions and methods for producing edible plant tissue biomasses suitable for use as nutritional supplements. Briefly, the seedlings are exposed to at least one metal and normal seedling growth is interrupted prior to the eleventh day following germination to produce a metal-enriched plant seedling tissue biomass. Metal-containing edible plant tissue biomasses are also provided.

In well-designed combinations with the other nutritional and phytochemical technologies detailed in this disclosure, it appears possible that plant-derived mineral technologies provide superior results for human health when administered simultaneously with other ingredients including plant phenolic compounds, polyphenols, polysaccharides, and carotenoids, in various nutritional product formulations.

Use of the interactions between vitamins, minerals and phytochemicals to modulate absorption and bioavailability of nutrients. Physical and chemical interaction between phytochemicals and certain vitamin and mineral nutrients can have dramatic effects on the bioavailability and/or biological fate of the nutrients. These interactions can be controlled to produce novel and commercially superior nutritional products with enhanced bioavailability and/or sustained release characteristics.

The present inventor has been recognized that to optimally control these interactions, one must analyze information about potential interactions that may occur between phytochemicals and nutrients with information about optimizing metabolic performance. By choosing proper combinations of interacting ingredients, enhanced effects are realized. Another important consideration is that plant extracts containing phytochemical agents may be standardized to ensure that the predicted and desired interactions will occur on a reproducible basis.

In one example of a beneficial interaction between a phytochemical and vitamins is demonstrated by the interaction of Aloe vera gel and vitamins C and E. It has been recently shown that Aloe vera gel given simultaneously with the administration of a water soluble vitamin, vitamin C, and a fat soluble vitamin, vitamin E, dramatically slowed down the absorption of both vitamins and resulted in sustained levels of the vitamins in plasma. The overall result is that Aloe gel improves the absorption profile of both vitamins C and E. Vinson, et al. (2005).

Another interaction between a phytochemical and a nutrient involves the antagonistic relationship that plant phenolic ingredients have on the absorption of non-heme iron. Plant phenolic compounds such as tannins and other polyphenols decrease the intestinal absorption of iron. This antagonistic relationship is generally portrayed in the scientific literature as an undesirable effect of certain foods containing plant phenolic ingredients to block iron absorption. Lopez and Martos (2004) and Ronca, et al. (2003). While the antagonistic effect is portrayed generally as an undesirable effect of certain foods containing plant phenolic ingredients to block iron absorption, it is recognized herein that the effect can be harnessed in a positive way, that is, by using the right types and concentrations of polyphenols, to slow the absorption of iron and possibly other minerals thereby creating a natural, extended-release mineral supplement.

In yet another example of a phytochemical-mineral nutrient interaction, xanthohumol, a prenylated chalcone derived from hops (Humulus lupulus L.) stimulates the uptake of iodine into the thyroid gland of rats. Radovic, et al. (2005). Unlike the previous case of plant phenolics decreasing the absorption of iron, in the case of xanthohumol, the interaction of a plant phenolic compound actually increases the uptake of another mineral nutrient, iodine. These observations not only demonstrate that phytochemical-mineral interactions can be both positive or negative in enhancing absorption, but in these cases, the same class of phytochemicals, plant phenolics, can have opposite effects depending on the mineral in question. The present invention takes advantage of this dichotomy for the first time to provide targeted, controlled uptake of certain minerals based on their interaction with specific compounds from the selected plant sources.

A different type of phytochemical-mineral nutrient interaction occurs with plant polysaccharides. Many plant polysaccharides, especially algal-derived polysaccharides that are often sulfated, show selective binding and release characteristics with certain ions, including ions that are important for human mineral nutrition. An example of this ion exchange mechanism is shown with the selective binding of calcium, zinc, copper and potassium ions with polysaccharide matrix of the green alga Mougeotia scalaris. Tretyn, et al. (1996). The selective and/or extended release of mineral ions from a dietary supplement formulation by the use of natural polysaccharides functioning as ion exchange matrices are of particular use with the present invention.

The present invention is based on the recognition that the selection of certain combinations of phytochemicals, vitamins and minerals and their method or source for delivery may be used to maximize the many desirable effects, such as enhancing the release and bioavailability characteristics of the nutrients.

Increasing absorption of vitamins by using plant-derived phenolic compounds to inhibit conjugation and elimination. Certain dietary compounds can increase the absorption of nutrients and/or drugs. In one study, plant-derived phenolic compounds, such as epicatechin, epigallocatechin galleate (ECGC), chrysin and quercetin, have been shown to increase the absorption of a model drug, alpha-napthol, by decreasing or eliminating the process of intestinal glucuronidation. Mizuma and Awazu (2004). In another study the effect of red and white wines on the absorption of cationic organic molecules was studied. The results suggested that red wine, which is rich in plant-derived phenolic components, increased the absorption of the tested cationic compound, MPP+. The authors suggest that that red wine may increase and white wine may decrease the intestinal absorption of organic cations, which include some drugs and vitamins such as thiamin and riboflavin. Monteiro, et al. (2005). It is recognized herein that the bioavailability of vitamins and other nutrients in a dietary supplement may be increased by suppression of intestinal glucuronidation by incorporating plant-derived phenolic compounds such as, flavonoids, apigenin, rutin, quercetin, chrysin, hesperidin, bioflavonoids, isoflavones, anthocyanins, chlorogenic acid, ECGC, lignins, ellagic acid, catechins, aescin, resveratrol, curcumin, gingerol, pygnogenol, and oleuropein into compositions that include bioavailable minerals, nutrients, and other active agents.

Harnessing complementary and competitive effects of vitamins and phytochemicals on detoxification metabolism. Environmental challenges such as air and water pollution, UV radiation and ingestion of xenobiotic chemical substances, including drug therapies, place strain on the human body's detoxification and repair mechanisms. The more challenges that are present simultaneously, the greater the risk of overloading the body's detoxification and repair mechanisms. If an individual has poor nutritional status, detoxification mechanisms, including the cytochrome P-450 mixed function oxidases, sulfotransferase, glucuronyl transferase and glutathione transferase, can become impaired. Nutritional factors, including vitamins that function as cofactors, riboflavin, ascorbic acid, and vitamins A and E, and minerals, including iron, copper, zinc and magnesium, can increase the efficiency of detoxification reactions in unique ways that are as yet not fully understood. Bidlack, et al. (1986).

The activity of human cytosolic glutathione S-transferases (GSTs), which are important detoxification enzymes, are inhibited by certain antioxidant vitamins including alpha-tocopherol (synthetic vitamin E), tocopherols (natural vitamin E) and tocotrieneols. van Haften, et al. (2002) and van Haften, et al. (2003). Additionally retinoid compounds, including vitamin A and vitamin A metabolites were found to inhibit mammalian glutathione transferases at low concentrations. Kulkarni and Kulkami (1995). It is further recognized herein that certain vitamins which are commonly found in dietary supplements, particularly A and E, can suppress detoxification mechanisms by, e.g., the glutathione S-transferase mechanisms.

Conversely, certain phytochemical agents, particularly those derived from cruciferous plants such as sulforaphanes and the glucosinolates, and including glucoraphanin and glucoerucin, are potent inducers of phase II detoxifying enzymes. Phase II detoxifying enzymes include glutathione transferases, NAD(P)H:quinone reductases, and epoxide hydrolases. Basten, et al. (2002), McWalter, et al. (2004), Barillari, et al. (2005) and Perocco, et al. (2006). Therefore, the present invention includes the use of brassica-derived phytochemicals in dietary supplement formulations to offset the reported suppression of glutathione transferases caused by vitamin A and vitamin E compounds. By combining these compounds it is possible to maximize the nutritional delivery of bioavailable agents to improve human health.

Another example of the present invention is the use of complementary interactions of other phase II detoxifying enzymes and nutritional factors to enhance metabolic effects of dietary supplement formulations containing vitamins and minerals. For example, DT-diaphorase, a NAD(P)H:quinone reductase enzyme, is critical to maintain the active reduced form of the antioxidant nutrient CoQ. Beyer, et al. (1996) and Beyer, et al. (1996). As presented in the previous example, this phase II enzyme can be induced by brassica-derived phytochemicals. But other nutrients can have substantial complementary effects on this enzyme as well. Nicotinate (niacin), a B vitamin is the precursor for the enzyme cofactor NAD, which is critical to the functioning of DT-diaphorase. It has been shown that supplemental amounts of nicotinate metabolites greatly increase the enzymatic activity of DT-diaphorase. Friedlos, et al. (1992). Synthesizing this information, is plausible that formulations containing a combination of nicotinate and brassica-derived phytochemicals have complementary and possibly synergistic roles for increasing the amount and activity of DT-diaphorase. This combined effect could in turn increase the amount of the reduced form of CoQ and possibly vitamin E within cells. Increasing the levels of reduced CoQ and/or vitamin E in cells would increase the cell's protection against oxidative stresses.

The trace mineral nutrient, vanadium, also exhibits protective effects toward the development of cancer. The mechanism of action of this mineral appears to be at least in part due to increasing the levels of detoxification enzymes, glutathione S-transferase and cytochrome P-450 mixed oxidases. Kanna, et al. (2005). Therefore, the coadministration of vanadium with brassica-derived phytochemicals and nicotinate could result in desirable increases in detoxification mechanisms by at least three distinct, possibly synergistic, activities. In addition to the value inherent in increasing detoxification ability, this novel combination of vitamin, mineral and phytochemical can potentially offset the suppression of certain detoxification pathways caused by tocotrieneols, vitamin A and vitamin E, creating a novel and improved multivitamin supplement.

Maximizing synergies between minerals and phytochemicals relating to bone health. Dietary intake of certain phytochemicals in the class known as carotenoids including, beta-carotene, lycopene, lutein and zeaxanthin, have been correlated positively with increased bone mineral density. Wattanapenpaiboon, et al. (2003). Furthermore, lycopene and beta-cryptoxanthin, have recently been shown to exhibit anti-osteoporosis effects that are distinct from those produced by supplementation with calcium and other mineral nutrients that are normally associated with the reduction of osteoporosis risk. In one study, lycopene prevented the formation of osteoclasts and osteoclastic mineral resorption. In another study, beta-cryptoxanthin exhibited synergistic anabolic effects on bone components in vitro when combined with the mineral zinc. Rao, et al. (2003) and Uchiyama, et al. (2005). Therefore it was further recognized that dietary supplement formulations that include carotenoids, such as lycopene or beta-cryptoxanthin, may be combined with synergistic ingredients such as zinc, and other vitamin and mineral ingredients associated with bone health, such as vitamin D, vitamin C, calcium, magnesium, and boron to facilitate increased bone health.

The present invention includes compositions and methods for the use and manufacture of enhanced release and uptake of nutrients and minerals in a dietary supplement formulation that includes one or more plant-derived minerals, one or more natural vitamins and one or more standardized phytochemicals that function synergistically to: 1) enhance the absorption of certain nutritional components; 2) modulate the availability of certain mineral nutrients; and 3) modulate effects of detoxification, conjugation and elimination as they relate to the absorption and processing of nutrients.

More particularly, the invention includes economical and commercially feasible formulations for addressing the aforementioned needs by incorporation of the selected ingredients into a convenient dosage form in which the necessary interactions of phytochemicals, natural vitamins and plant-derived minerals may be achieved by the simultaneous administration of these ingredients, e.g., in a single dosage form, e.g., capsules, tablets, mini-tablets, caplets, gelcaps, geltabs, powder, liquid and combinations thereof. The present invention also include chewable formulations that are of particular appeal to those users that do not like solid tablet formulations, gritty liquids and the like. Chewable and chewable digestible formulations find particular appeal among children, in particular when provided with a natural source of sugar or sugar-like agents.

Examples. One embodiment of the present invention is a single dosage form that includes an all-natural, dietary supplement formulation with a plant-derived mineral source, natural vitamins and standardized phytochemicals.

A Plant-Derived Mineral Source: 125 milligrams per capsule of Brassica juncea (Indian mustard) powder containing 12 mg/g iron, 400 mcg/gram selenium, 600 mcg/gram chromium, 35 mg/g zinc, 4 mg/g copper, 6 mg/g manganese, 200 mcg/g vanadium, 200 mcg/g molybdenum, 2 mg/g boron, 300 mcg/g iodine, and 2 mg/g strontium. The capsule may further include

Vitamins ˜25% Daily Value (% DV) per dosage form, e.g., Natural source vitamin B complex (thiamine, riboflavin, niacin, vitamin B6, pantothenic acid, folate, vitamin B12); Natural source vitamin A (retinol, beta-carotene, mixed carotenoids); Natural vitamin C (ascorbic acid, vitamin-C complex); Natural vitamin D; and/or Natural vitamin E (mixed tocopherols).

Standardized Phytochemicals, Broccoli extract standardized to 6.0% glucosinolates-20 mg/capsule; Lycopene standardized to 10%-20 mg/capsule; Beta-Carotene (mixed carotenoids) standardized to 3 or 10%-40 mg/capsule; Lutein standardized to 10%-25 mg/capsule; Grape pomace extract standardized to 50% polyphenols-20 mg/capsule; Cranberry extract standardized to 35% organic acids-20 mg/capsule; Green tea extract standardized to 95% polyphenols and 50% ECGC; Rutin NF 10 mg/capsule; aloe gel 200×20 mg and/or Aquamins and other minerals, e.g., Ca and Mg.

Yet another embodiment of the present invention includes a dietary supplement formulation to support bone health that includes a plant-derived mineral source, one or more vitamins and one or more standardized phytochemicals. Examples of Plant-Derived Mineral Sources include 125 milligrams per capsule of Brassica juncea (Indian mustard) powder containing 30 mg/g zinc, 2 mg/g boron, 2 mg/g strontium; Vitamins ˜25% Daily:Value (% DV) per Capsule, e.g., Natural vitamin C (ascorbic acid, vitamin C complex) and/or Natural vitamin D; and Standardized Phytochemicals such as Lycopene standardized to 10%-20 mg/capsule; Beta-Carotene standardized to 3-10%-40 mg/capsule; Lutein standardized to 10%-25 mg/capsule; aloe gel 200×20 mg; and/or Aquamins and other minerals, e.g., Ca and Mg.

Yet another example includes an encapsulated or compressed, all natural dietary supplement for enhanced vitamin absorption by suppression of intestinal glucuronidation that includes: a Plant-Derived Mineral Source such as 125 milligrams per capsule of Brassica juncea (Indian mustard) powder containing 12 mg/g iron, 400 mcg/gram selenium, 600 mcg/gram chromium, 35 mg/g zinc, 4 mg/g copper, 6 mg/g manganese, 200 mcg/g vanadium, 200 mcg/g molybdenum, 2 mg/g boron, 300 mcg/g iodine, 2 mg/g strontium; and Vitamins ˜25% Daily Value (% DV) per Capsule with: Natural source vitamin B complex (thiamine, riboflavin, niacin, vitamin B6, pantothenic acid, folate, vitamin B12); Natural source vitamin A (retinol, mixed carotenoids, beta-carotene); Natural vitamin C (ascorbic acid, vitamin C complex); Natural vitamin D; and/or Natural vitamin E (mixed tocopherols); and Standardized Phytochemicals, e.g., Grape pomace extract standardized to 50% polyphenols-20 mg/capsule; Cranberry extract standardized to 35% polyphenols-20 mg/capsule; Green tea extract standardized to 95% polyphenols and 50% ECGC; Rutin NF-20 mg/capsule; Quercetin standardized to 95%-20 mg/capsule; aloe gel 200×20 mg.; and/or Aquamins and other minerals, e.g., Ca and Mg.

Another example is an encapsulated, all natural dietary supplement for modulated mineral absorption by plant phenolic compounds: namely, Plant-Derived Mineral Source: 125 milligrams per capsule of Brassica juncea (Indian mustard) powder containing 12 mg/g iron, 400 mcg/gram selenium, 600 mcg/gram chromium, 35 mg/g zinc, 4 mg/g copper, 6 mg/g manganese, 200 mcg/g vanadium, 200 mcg/g molybdenum, 2 mg/g boron, 300 mcg/g iodine, 2 mg/g strontium; Vitamins 25% Daily Value (% DV) per Capsule, e.g., Natural source vitamin B complex (thiamine, riboflavin, niacin, vitamin B6, pantothenic acid, folate, vitamin B12); Natural source vitamin A (retinol, mixed carotenoids); Natural vitamin C (ascorbic acid, vitamin C complex); Natural vitamin D; Natural vitamin E (mixed tocopherols); and Standardized Phytochemicals, e.g., Beta-Carotene standardized to 3-10%-40 mg/capsule; Grape pomace extract standardized to 50% polyphenols-20 mg/capsule; Cranberry extract standardized to 35% organic acids-20 mg/capsule; and/or Green tea extract standardized to 95% polyphenols and 50% ECGC; aloe gel 200×20 mg.; and/or Aquamins and other minerals, e.g., Ca and Mg.

Another example is a pill, powder, capsule, caplet, gelcap, minitab and combinations thereof that include an all natural dietary supplement for overcoming suppression of glutathione transferase by vitamins A or E, with, e.g., a Plant-Derived Mineral Source: 125 milligrams per capsule of Brassica juncea (Indian mustard) powder containing 12 mg/g iron, 400 mcg/gram selenium, 600 mcg/gram chromium, 35 mg/g zinc, 4 mg/g copper, 6 mg/g manganese, 200 mcg/g vanadium, 200 mcg/g molybdenum, 2 mg/g boron, 300 mcg/g iodine, 2 mg/g strontium; one or more Vitamins (e.g., 25% Daily Value (% DV) per Capsule), such as Natural source vitamin B complex (thiamine, riboflavin, niacin, vitamin B6, pantothenic acid, folate, vitamin B12); Natural source vitamin A (retinol, mixed carotenoids); Natural vitamin C (ascorbic acid, vitamin C complex); Natural vitamin D; Natural vitamin E (mixed tocopherols); and/or one or more Standardized Phytochemicals, e.g., Broccoli extract standardized to 6.0% glucosinolates-20 mg/capsule and/or Beta-Carotene standardized to 3-10%-40 mg/capsule; aloe gel 200×20 mg; and/or aquamins and other minerals, e.g., Ca and Mg.

Yet another embodiment of the present invention includes a composition of Table 1. The skilled artisan will recognize that the total amount of, in this case a tablet, may be varied according to the dosage requirement of the user, number of doses and other requirements. In some embodiments the dosage form may be a liquid, e.g., an intravenous or orally delivered liquid for individuals that are unable or unwilling to take a solid, enveloped form of the composition. The composition may even be provided in dry form and added to a liquid or a concentrated form that is diluted for use. The dry or concentrated form may be added to water or other solution, e.g., an isotonic solution or other solution for final use.

TABLE 1
Composition Components and Relative Ratios

| | Actual | | | | | | | |
|---|---|---|---|---|---|---|---|---|
| | ingredient | | | | | | | |
| | amount | Tablet | | Daily | | | | |
| | per tablet | claim | | claim 4x | | | | |
| Ingredient name | (mg) | (mg/IU) | | (mg) | | DV | | % DV |
| InB Mineral Blend (mg) | 125 | | | | | | | |
| zinc (mg) | | 3.500 | | 14.000 | | 15 | mg | 93 |
| iron (mg) | | 1.200 | | 4.800 | | 18 | mg | 27 |
| manganese (mg) | | 0.600 | | 2.400 | | 2 | mg | 120 |
| chromium (mg) | | 0.060 | | 0.240 | | 0.120 | mg | 200 |
| copper (mg) | | 0.400 | | 1.600 | | 2 | mg | 80 |
| selenium (mg) | | 0.040 | | 0.160 | | 0.070 | mg | 228 |
| vanadium (mg) | | 0.020 | | 0.080 | | n/a | | |
| molybdenum (mg) | | 0.020 | | 0.080 | | 0.075 | mg | 94 |
| boron (mg) | | 0.200 | | 0.800 | | n/a | | |
| iodine (mg) | | 0.030 | | 0.120 | | 0.150 | mg | 80 |
| “Aquamins” - 30% Ca (mg) | 100 | 30.00 | | 120 | | 1000 | mg | 12 |
| “Aquamins” - 2.5% Mg (mg) | | 2.50 | | 10.0 | | 400 | mg | 2.5 |
| BroccoSinolate 6% glucosinolates | 20 | 1.20 | | 4.8 | | n/a | | 4.8 mg |
| (mg) | | | | | | | | glucosinolates |
| Rutin NF (mg) | 20 | 20.00 | | 80.0 | | n/a | | |
| Cranberry extract (35% org | 20 | 7.00 | | 28.0 | | n/a | | 28 mg |
| acids) (mg) | | | | | | | | organic acids |
| Grape pomace extract (50% poly) | 20 | 10.00 | | 40.0 | | n/a | | 40 mg |
| (mg) | | | | | | | | polyphenols |
| Aloe gel powder (200x) (mg) | 20 | 20.0 | | 80.0 | | 20 | mg | |
| Yeast vitamin complex (mg) | 500 | | | | | | | |
| thiamin (mg) | | 0.375 | | 1.50 | | 1.5 | mg | 100 |
| riboflavin (mg) | | 0.400 | | 1.60 | | 1.7 | mg | 94 |
| niacin (mg) | | 4.000 | | 16.0 | | 20.0 | mg | 80 |
| pyridoxine - vitamin B6 (mg) | | 0.550 | | 2.20 | | 2.0 | mg | 110 |
| pantothenic acid (mg) | | 1.375 | | 5.50 | | 10.0 | mg | 55 |
| folic acid (mg) | | 0.100 | | 0.40 | | 0.400 | mg | 100 |
| biotin (mg) | | 0.038 | | 0.15 | | 0.300 | mg | 50 |
| Mixed carotenoid powder (35,000 IU/g) | 35.75 | 1250 | IU | 5000 | IU | 5000 | IU | 100 |
| | | | | | | | Vit A | |
| Vitamin B12 1% (yeast derived) | 0.15 | 0.0015 | | 0.0060 | | 6 | mcg | 100 |
| (mcg) | | | | | | | | |
| Acerola cherry (15% Vitamin C) | 100.00 | 15.00 | | 60.0 | | 60 | mg | 100 |
| (mg) | | | | | | | | |
| Vitamin D (100K IU/g) | 1.00 | 100 | IU | 400 | IU | 400 | IU | 100 |
| | | | | | | | vit D | |
| Vitamin E (350 IU/g) | 21.50 | 7.5 | IU | 30 | IU | 30 | IU vit E | 100 |

The skilled artisan will also recognize that the percentage of the components listed in the table hereinabove may be varied from 0 to 80 or even 90 percent, depending on the formulation requirements.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

In the claims, all transitional phrases such as “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

Orser, et al. (1998/1999) Brassica Plants to Provide Enhanced Human Mineral Nutrition: Selenium Phytoenrichment and Metabolic Transformation. Journal of Medicinal Food. 1 (4) 253-61.
Elless, et al. (2000) Plants as a Natural Source of Concentrated Mineral Nutritional Supplements. Food Chemistry. 71 181-8.
van Haften, et al. (2002) Tocotrieneols Inhibit Human Glutathione S-transferase P1-1. IUBMB Life. 54 (2) 81-4
van Haften, et al. (2003) Inhibition of Various Glutathione S-transferase Isoenzymes by RRR-alpha-tocopherol. Toxicol. In Vitro. 17 (3) 245-51
Kulkarni and Kulkarni (1995) Retinoids Inhibit Mammalian Glutathione Transferases. Cancer Lett. 8; 91 (2) 185-9
Basten, et al. (2002) Sulforaphane and Its Glutathione Conjugate but Not Sulforaphane Nitrile Induce UDP-Glucuronosyl Transferase (UGT1A1) and Glutathione Transferase (GSTA1) in Cultured Cells. Carcinogenesis 23 (8) 1399-1404.
McWalter, et al. (2004) Transcription Factor Nrf2 Is Essential for Induction of NAD(P)H:Quinone Oxidoreductase 1, Glutathione S-Transferase, and Glutamyte Cysteine Ligase by Broccoli Seeds and Isothiocyanates. J. Nutr. 134Suppl 3499S-3506S.
Barillari, et al. (2005) Direct Antioxidant Activity of Purified Glucoerucin, the Dietary Secondary Metabolite Contained in Rocket (Eruca sativa Mill.) Seeds and Sprouts. J Agric Food Chem. 53 (7) 2475-82
Perocco, et al. (2006) Glucoraphanin, the Bioprecursor of the Widely Extolled Chemopreventative Agent Sulforaphane Found in Brocolli, Induces Phase-I Xenobiotic Metabolizing Enzymes and Increases Free Radical Generation in Rat Liver. Mutat Res. Epub ahead of print
Bidlack, et al. (1986) Nutritional Parameters that Alter Hepatic Drug Metabolism, Conjugation, and Toxicity. Fed Proc. 45 (2) 142-8
Vinson, et al. (2005) Effects of Aloe vera Preparations on the Human Bioavailability of Vitamins C and E. Phytomedicine 12 (10) 760-5
Lopez and Martos (2004) Iron Availability: An Updated Review. Int J Food Sci Nutr. 55 (8) 597-606
Ronca, et al. (2003) Relationship Between Iron and Protein Content of Dishes and Polyphenol Content in Accompanying Wines. Drugs Exp Clin Res. 29 (5-6) 271-86
Radovic, et al. (2005) Xanthohumol Stimulates Iodine Uptake in Rat Thyroid-Derived FRTL-5 Cells. Mol Nutr Food Res. 49 (9) 832-6.
Tretyn, et al. (1996) Selective Binding of Ca2+, Zn2+, Cu2+, and K⁺ by the Physodes of the Green Alga Mougeotia scalaris. Folia Histochem Cytobiol. 34 (2) 103-8.
Beyer, et al. (1996) The Role of DT-Diaphorase in the Maintenance of the Reduced Antioxidant Form of Coenzyme Q in Membrane Systems. Proc Natl Acad Sci USA. 93 (6) 2528-32.
Beyer, et al. (1997) The Two-Electron Quinone Reductase DT-Diaphorase Generates and Maintains the Antioxidant (Reduced) Form of Coenzyme Q in Membranes. Mol Aspects Med. 18 Suppl S15-23.
Friedlos, et al. (1992) Potentiation of CB 1954 Cytotoxicity by Reduced Pyridine Dinucleotides in Human Tumor Cells by Stimulation of DT-Diaphorase Activity. Biochem Pharmacol. 44 (9) 1739-43.
Kanna, et al. (2005) Vanadium Inhibits DNA-Protein Cross-Links and Ameliorates Surface Level Changes of Abberrant Crypt Foci during 1,2-Dimethylhydrazine Induced Rat Colon Carcinogenesis. Cell Biol Toxicol. 21 (1) 41-52.
Wattanapenpaiboon, et al. (2003) Dietary Carotenoid Intake as a Predictor of Bone Mineral Density. Asia Pac J Clin Nutr 12 (4) 467-73.
Rao, et al. (2003) Lycopene I-Effect on Osteoclasts: Lycopene Inhibits Basal and Parathyroid Hormone-Stimulated Osteoclast Formation and Mineral Resorption Mediated by Reactive Oxygen Species in Rat Bone Marrow Cultures. Journal of Medicinal Foods. 6 (2) 69-78.
Uchiyama, et al. (2005) Synergistic Effects of Beta-Cryptoxanthin and Zinc Sulfate on the Bone Component in Rat Femoral Tissue in Vitro: The Unique Anabolic Effect with Zinc. Biol Pharm Bull. 28 (11) 2142-5.
Mizuma and Awazu (2004) Dietary Polyphenols (−)-Epicatechin and Chrysin Inhibit Intestinal Glucuronidation Metabolism to Increase Drug Absorption. Journal of Pharmaceutical Sciences. 93 (9) 2407-10.
Monteiro, et al. (2005) Intestinal Uptake of MPP+ is Differently Affected by Red and White Wine. Life Sciences. 76 2483-96.
U.S. Pat. No. 6,270,809—Ensley, et al. (Aug. 7, 2001) Nutritional Supplements.

What is claimed is:

1. A dietary supplement formulation comprising a standardized source of plant-derived minerals, one or more natural vitamins or provitamins, and one or more plant extracts.

2. The supplement of claim 1, wherein the plant-derived minerals are selected from the group consisting of seedlings of Brassica napus, Brassica rapa, Brassica juncea, Medicago sativa, and Oryzae sativa seeds.

3. The supplement of claim 1, wherein the plant-derived minerals comprises one or more of the minerals selected from calcium, magnesium, iron, zinc, selenium, chromium, vanadium, copper, manganese, molybdenum, boron, iodine, strontium, and combinations thereof.

4. The supplement of claim 1, wherein the one or more natural vitamins are selected from vitamin A, beta-carotene alone, carotenoids, lycopene, lutein, zeaxanthin, cryptoxanthin, thiamine (vitamin B₁), riboflavin (vitamin B₂), niacin (vitamin B₃), pantothenic acid (vitamin B₅), pyridoxine (vitamin B₁), folate (vitamin B₉), cyanocobalamin (vitamin B₁₂), vitamin C-complex, vitamin D, vitamin E, tocopherols, tocotrieneols, and combinations thereof.

5. The supplement of claim 1, wherein the one or more standardized phytochemicals comprising, sulforaphanes, isothiocyanates, glucosinolates, glucoraphanin, gluconasturtiin, glucobrassicin, glucoerucin, S-methyl cysteine sulfoxide, indole-3-carbinol, erucin, xanthophylls, carotenoids, lycopene, lutein, cryptoxanthin, beta-carotene, polyphenolics, flavonoids, apigenin, rutin, quercetin, chrysin, hesperidin, bioflavonoids, isoflavones, anthocyanins, chlorogenic acid, ECGC, ellagic acid, catechins, aescin, resveratrol, curcumin, lignins, carnosic acid, rosemarinic acid, gingerol, oleuropein, silymarin, sinigrin, quinic acid, and, combinations thereof.

6. The supplement of claim 1, further comprising a natural polysaccharide ingredient comprising a plant polysaccharide, an algal polysaccharide, a fungal polysaccharide, a bacterial polysaccharide, a plant gum, aloe polysaccharide, and combinations thereof.

7. The supplement of claim 1, wherein the supplement is placed inside an external capsule, a vegetable capsule or a hard gelatin capsule.

8. The supplement of claim 1, wherein supplement is compressed at a pressure greater than 2,000 psi.

9. The supplement of claim 1, wherein about 85% of the nutritional supplements are released from between about 1 to about 8 hours.

10. The supplement of claim 1, wherein the nutritional supplements are in liquid, semi-solid, solid, gummy, gum, encapsulated or table form.

11. The supplement of claim 1, wherein the supplement further comprises one or more excipients.

12. A dietary supplement formulation to support bone health comprising a standardized source of plant-derived zinc, a standardized plant extract comprising vitamin A; beta-carotene, carotenoids, lycopene, lutein, zeaxanthin, cryptoxanthin, thiamine (vitamin B₁), riboflavin (vitamin B₂), niacin (vitamin B₃), pantothenic acid (vitamin B₅), pyridoxine (vitamin B₁), folate (vitamin B₉), cyanocobalamin (vitamin B₁₂), vitamin C-complex, vitamin D, vitamin E, tocopherols, tocotrieneols, and one or more additional nutrients comprising vitamin D, vitamin C, calcium, magnesium, strontium, and boron.

13. The supplement of claim 12, wherein the plant-derived minerals are selected from the group consisting of seedlings of Brassica napus, Brassica rapa, Brassica juncea, Medicago sativa, and Oryzae sativa seeds.

14. The supplement of claim 12, further comprising a natural polysaccharide ingredient comprising a plant polysaccharide, an algal polysaccharide, a fungal polysaccharide, a bacterial polysaccharide, a plant gum, aloe polysaccharide, and combinations thereof.

15. The supplement of claim 12, wherein the plant-derived minerals further comprises one or more of the minerals selected from iron, selenium, chromium, vanadium, copper, manganese, molybdenum, iodine, boron, zinc, and combinations thereof.

16. The supplement of claim 12, wherein the one or more natural vitamins are selected from vitamin A, carotenoids, thiamine (vitamin B₁), riboflavin (vitamin B₂), niacin (vitamin B₃), pantothenic acid (vitamin B₅), pyridoxine (vitamin B₁), folate (vitamin B₉), cyanocobalamin (vitamin B₁₂), vitamin C, vitamin D, vitamin E, tocopherols, tocotrieneols, and combinations thereof.

17. The supplement of claim 12, wherein the composition comprises a bulk powder, a chewable form or is adapted for use by children.

18. The supplement of claim 12, wherein the one or more standardized phytochemicals comprising, sulforaphanes, isothiocyanates, glucosinolates, glucoraphanin, gluconasturtiin, glucobrassicin, glucoerucin, S-methyl cysteine sulfoxide, indole-3-carbinol, erucin, xanthophylls, carotenoids, lycopene, lutein, cryptoxanthin, beta-carotene, polyphenolics, flavonoids, apigenin, rutin, quercetin, chrysin, hesperidin, bioflavonoids, isoflavones, anthocyanins, chlorogenic acid, ECGC, ellagic acid, catechins, aescin, resveratrol, curcumin, lignins, carnosic acid, rosemarinic acid, gingerol, oleuropein, silymarin, sinigrin, quinic acid, and combinations thereof.

19. The supplement of claim 12, wherein the supplement is placed inside an external capsule, a vegetable capsule or a hard gelatin capsule.

20. The supplement of claim 12, wherein supplement is compressed at a pressure greater than 2,000 psi.

21. The supplement of claim 12, wherein about 85% of the nutritional supplements are released from between about 1 to about 8 hours.

22. The supplement of claim 12, wherein the nutritional supplements are in liquid, semi-solid, solid, gummy, gum, encapsulated or table form.

23. The supplement of claim 12, wherein the supplement further comprises one or more excipients.

24. A dietary supplement formulation for enhanced vitamin absorption by suppression of intestinal glucuronidation comprising a standardized source of plant-derived minerals comprising, calcium, magnesium, iron, zinc, selenium, chromium, vanadium, copper, manganese, molybdenum, boron, iodine, and strontium; one or more natural vitamins or provitamins comprising, vitamin A, carotenoids, lycopene, lutein, zeaxanthin, cryptoxanthin, thiamine (vitamin B₁), riboflavin (vitamin B₂), niacin (vitamin B₃), pantothenic acid (vitamin B₅), pyridoxine (vitamin B₁), folate (vitamin B₉), cyanocobalamin (vitamin B₁₂), vitamin C, vitamin D, vitamin E, tocopherols, tocotrieneols; and one or more standardized plant extracts comprising plant phenolic compounds, polyphenolics, flavonoids, apigenin, rutin, quercetin, chrysin, hesperidin, bioflavonoids, isoflavones, anthocyanins, chlorogenic acid, ECGC, ellagic acid, catechins, aescin, resveratrol, curcumin, lignins, tannins, tannic acid, gingerol, and oleuropein.

25. The supplement of claim 24, further comprising a natural polysaccharide ingredient comprising a plant polysaccharide, an algal polysaccharide, a fungal polysaccharide, a bacterial polysaccharide, a plant gum, aloe polysaccharide, and combinations thereof.

26. The supplement of claim 24, wherein the supplement is placed inside an external capsule, a vegetable capsule or a hard gelatin capsule.

27. The supplement of claim 24, wherein supplement is compressed at a pressure greater than 2,000 psi.

28. The supplement of claim 24, wherein about 85% of the nutritional supplements are released from between about 1 to about 8 hours.

29. The supplement of claim 24, wherein the nutritional supplements are in liquid, semi-solid, solid, gummy, gum, encapsulated or table form.

30. The supplement of claim 24, wherein the supplement further comprises one or more excipients.

31. A dietary supplement formulation for modulated mineral absorption containing a standardized source of plant-derived minerals comprising, calcium, magnesium, iron, zinc, selenium, chromium, vanadium, copper, manganese, molybdenum, boron, iodine, and strontium; one or more natural vitamins or provitamins comprising, vitamin A, carotenoids, lycopene, lutein, zeaxanthin, cryptoxanthin, thiamine, riboflavin, niacin, vitamin B-6, folate, vitamin B-12, vitamin C, vitamin D, vitamin E, tocopherols, tocotrieneols; and one or more standardized plant extracts comprising plant phenolic compounds, polyphenolics, flavonoids, apigenin, rutin, quercetin, chrysin, hesperidin, bioflavonoids, isoflavones, anthocyanins, chlorogenic acid, ECGC, ellagic acid, catechins, aescin, resveratrol, curcumin, lignins, tannins, tannic acid, gingerol, and oleuropein.

32. The supplement of claim 31, further comprising a natural polysaccharide ingredient comprising a plant polysaccharide, an algal polysaccharide, a fungal polysaccharide, a bacterial polysaccharide, a plant gum, aloe polysaccharide, and combinations thereof.

33. The supplement of claim 31, wherein the supplement is placed inside an external capsule, a vegetable capsule or a hard gelatin capsule.

34. The supplement of claim 31, wherein supplement is compressed at a pressure greater than 2,000 psi.

35. The supplement of claim 31, wherein about 85% of the nutritional supplements are released from between about 1 to about 8 hours.

36. The supplement of claim 31, wherein the nutritional supplements are in liquid, semi-solid, solid, gummy, gum, encapsulated or table form.

37. The supplement of claim 31, wherein the supplement further comprises one or more excipients.

38. A dietary supplement formulation for overcoming suppression of glutathione transferase by vitamins A or E containing a standardized source of plant-derived minerals comprising, calcium, magnesium, iron, zinc, selenium, chromium, vanadium, copper, manganese, molybdenum, boron, iodine, and strontium; and one or more natural vitamins or provitamins comprising, vitamin A, carotenoids, lycopene, lutein, zeaxanthin, cryptoxanthin, thiamine, riboflavin, thiamine (vitamin B₁), riboflavin (vitamin B₂), niacin (vitamin B₃), pantothenic acid (vitamin B₅), pyridoxine (vitamin B₁), folate (vitamin B₉), cyanocobalamin (vitamin B₁₂), vitamin C, vitamin D, vitamin E, tocopherols, tocotrieneols; and one or more standardized plant extracts comprising one or more of the following, sulforaphanes, isothiocyanates, glucosinolates, glucoraphanin, gluconasturtiin, glucobrassicin, glucoerucin, sinigrin, S-methyl cysteine sulfoxide, indole-3-carbinol, erucin, and combinations thereof.

39. The supplement of claim 38, further comprising a natural polysaccharide ingredient comprising a plant polysaccharide, an algal polysaccharide, a fungal polysaccharide, a bacterial polysaccharide, a plant gum, aloe polysaccharide, and combinations thereof.

40. The supplement of claim 38, wherein the supplement is placed inside an external capsule, a vegetable capsule or a hard gelatin capsule.

41. The supplement of claim 38, wherein supplement is compressed at a pressure greater than 2,000 psi.

42. The supplement of claim 38, wherein about 85% of the nutritional supplements are released from between about 1 to about 8 hours.

43. The supplement of claim 38, wherein the nutritional supplements are in liquid, semi-solid, solid, gummy, gum, encapsulated or table form.

44. The supplement of claim 38, wherein the supplement further comprises one or more excipients.

45. A method of providing a balanced nutritional supplement comprising the steps of selecting one or more standardized source of plant-derived minerals, one or more natural vitamins or provitamins and one or more plant extracts, wherein the one or more components of the supplement are synergistic as measured by bioavailability.

46. The method of claim 45, wherein the composition comprises a standardized source of plant-derived minerals comprising, calcium, magnesium, iron, zinc, selenium, chromium, vanadium, copper, manganese, molybdenum, boron, iodine, and strontium; one or more natural vitamins or provitamins comprising, vitamin A, carotenoids, lycopene, lutein, zeaxanthin, cryptoxanthin, thiamine (vitamin B₁), riboflavin (vitamin B₂), niacin (vitamin B₃), pantothenic acid (vitamin B₅), pyridoxine (vitamin B₁), folate (vitamin B₉), cyanocobalamin (vitamin B₁₂), vitamin C, vitamin D, vitamin E, tocopherols, tocotrieneols; and one or more standardized plant extracts comprising plant phenolic compounds, polyphenolics, flavonoids, apigenin, rutin, quercetin, chrysin, hesperidin, bioflavonoids, isoflavones, anthocyanins, chlorogenicpantothenic acid, ECGC, ellagic acid, catechins, aescin, resveratrol, curcumin, lignins, tannins, tannic acid, gingerol, oleuropein, and combinations thereof.

47. The method of claim 45, wherein the supplement is placed inside an external capsule, a vegetable capsule or a hard gelatin capsule.

48. The method of claim 45, wherein supplement is compressed at a pressure greater than 2,000 psi.

49. The method of claim 45, wherein about 85% of the nutritional supplements are released from between about 1 to about 8 hours.

50. The method of claim 45, wherein the nutritional supplements are in liquid, semi-solid, solid, gummy, gum, encapsulated or table form.

51. The method of claim 45, wherein the supplement further comprises one or more excipients.
